(19) United States
(12) Patent Application Publication
(10) Pub. No.: US 2026/0312671 A1
(43) Pub. Date: Oct. 8, 2026

(54) NETWORK CREATION PROCESS FOR INTERNET SUPPLY TO THE EARTH'S COMPLETE LAND SURFACE, THE PAYLOAD AND AIRCRAFT ENABLING ITS IMPLEMENTATION

(71) Applicant: PRODOSE, Bessieres (FR)

(72) Inventor: Morou Boukari, Toulouse (FR)

(21) Appl. No.: 17/490,281

(22) Filed: Sep. 30, 2021

Related U.S. Application Data
(63) Continuation-in-part of application No. 16/634,488, filed on Jul. 26, 2018, now Pat. No. 11,139,885.
(60) Provisional application No. 62/537,559, filed on Jul. 27, 2017.

(30) Foreign Application Priority Data
Jul. 27, 2017 (FR) 1757121

(51) Int. Cl. H04B 7/185

(52) U.S. Cl. CPC H04B 7/18508; H04B 7/18523

(57) ABSTRACT

The invention relates to a network creation method for the provision of internet and/or television type data signals across the Earth's complete land surface,
remarkable in that it interconnects at least one airplane (300) with the earth station (200) on one hand and on the other hand with at least one emission and receipt means that are fixed or borne by at least one user (400),
   the said airplane (300) transports passengers and/or freight of er five hundred kilograms,
   will move to an altitude less than or equal to ten kilometers above the global land surface,
   transports at least one person, and
being equipped with or several payloads powered by the airplane's energy (300) in such a way as to use emission and receipt relays for the provision of at least one type of signal on the global land surface.

The invention also relates to the airplane for implementing the said method.

### THE INVENTION'S DOMAIN OF APPLICATION

This invention relates to the domain of internet type network implementation and particularly customizations that enable offering this service across the complete land surface in the best conditions.

### DESCRIPTION OF THE PRIOR ART

There are several solutions to provide internet to the complete land surface through wireless communication.

For example there are constellations and programs for constellations of artificial satellites to provide internet to the global land surface and for air-ground/ground-air transmission of digital data.

These satellites are classically equipped:
with a platform that ensures the function of electric power supply, propulsion and maintaining altitude to the satellite.
with a payload including one or several repeaters made up of the following elements:
   one or multiple ground-air data receipt antennas originating from one or several earth stations,
   one or several amplification and polarization modules for signals received from the Earth,
   one or several air-ground emission antennas for amplified signals to the ground.
      These artificial satellites however pose several disadvantages, that are described hereafter.
      They generate a lot of debris in space around the Earth (currently over twenty thousand pieces of debris) and of the five thousand satellites launched since 1957, only one thousand four hundred are operational in 2016, those remaining are non-operational and clutter up space.
      They also have limited power. In fact, currently, the maximum power of the largest satellite is twenty-two kilowatts.
      They are dedicated to their single function.
      Their production and launch costs are very high.
      It is not possible to repair them or change defective parts once they have been launched into space and are revolving in their orbit.
      They rotate at a fixed height and orbit around the Earth.
      The payload has very restricted weight considering the technical constraints of launch devices and launch costs (currently, the maximum weight is eight tons with a payload under five tons). SO, for example, the current maximum number of repeaters for the largest satellite is under seventy.
      The air-ground data transmission flow is weak.
      To avoid loss of signal on the ground and considering the fact that these satellites rotate at over one hundred kilometers around the Earth, the opening angle of air-ground emission antennas is very small (under sixty degrees),
      The protection of payloads and satellite platforms requires the use of noble metals, considering the highly aggressive environment in which these satellites evolve.

There are also air-ground internet provision projects using helium-filled balloons or pilotless solar airplanes flying in the stratosphere (between fourteen and twenty kilometers), but these projects have many of the disadvantages that satellite constellations have, for example:
lower but not negligible cost,
a dedicated function,
a restricted coverage area (under one hundred kilometers on the ground) and very low emission power (under one kilowatt).

### DESCRIPTION OF THE INVENTION

Starting from this point, the searchers conducted research targeted at offering an alternative to the deployment of satellites or additional aircraft dedicated to the creation of a wireless data network of internet and/or television type.

The research culminated with the design and creation of a network creation method for the provision of internet and/or television type data signals across the complete land surface,
in which the surface receives
at least one earth station for emission and receipt of internet and/or television type data signals.

The said method is remarkable in that it interconnects at least one airplane with the earth station for emission and receipt of internet and/or television type data signals on one hand and on the other hand with at least one emission and receipt means for data signals of internet and/or television type that are individual or collective, fixed or borne by at least one user,
the said airplane transports passengers and/or freight of over five hundred kilograms,
will move to an altitude less than or equal to ten kilometers above the global land surface,
transports at least one person, and
   being equipped with Or Several payloads powered by the airplane's energy in such a as to use emission and receipt relays for the provision of at least one type of signal on the global land surface.

The invention thus consists of making passenger transport airplanes carry the functional equivalent of the payload until now borne by satellites. These airplanes have a bay and therefore the power required to transport such an additional payload.

The operation of passenger airplanes for this purpose has multiple advantages.

There are currently tens of thousands of civil passenger transport airplanes that perform hundreds of thousands of flights every day, covering almost the complete global land surface in the space located between zero and ten kilometers of altitude.

By equipping all these airplanes with payloads of the type specified above, that equip artificial satellites with technical adaptations (modifications), the aim of the invention is to build a constellation of airplanes that will provide both passenger transport and air-ground/ground-air provision of internet connections across the complete global land surface at least cost (cost reduction by a factor of hundred to thousand) with respect to artificial Satellites. Such a network can substitute or add on to the already existing networks,

The invention thus enables providing internet connections across the complete global land surface by using current and future passenger transport airplanes and by equipping these airplanes with payloads of the type used in artificial satellites, based on technical adaptations (modifications).

Of course, at present, there are passenger transport airplanes equipped to provide internet to the passengers (up to five hundred passengers) by receiving signals from an earth station or a satellite. However, these types of airplanes are not equipped to provide internet on the ground like the invention proposes.

The airplanes are also equipped with methods indispensable to their navigation (anti-collision, alert, maintenance). These are means to receive ground-air signals, means for emission of air-ground signals and means for air-air signals. These navigation means are not adapted and are not meant to provide internet (air-ground) to the global land surface. However, these means will enable tracking airplanes by earth stations for emission and receipt that make up the network.

The invention enables planning a new economic method by offering a new source of profitability upon operation of current and future civil airplanes.

By operating airplanes meant for passenger and/or freight transport, the invention avoids traffic congestion and pollution in the sky and space through debris of satellites and satellites at the end of their operational life.

Based on a factor from hundred to over a thousand, the invention enables reducing production costs, operation of payloads of satellites and air-ground and ground-air transmission systems for digital data. For example, it is no longer necessary to use noble metals to protect payloads in air-ground transmission devices for digital data.

The invention thus promotes internet access at lowest cost to the entire global population.

The functional equivalent of the payload will directly use electric power from the airplane or its fuel. It is not necessary to have a platform for this like for a satellite. The airplane payload can thus provide over 500 kilowatts.

Additionally, airplanes operation provides the possibility to repair the payload and change defective parts once the airplane touches down. Airplanes can transport a payload that can attain from fifty to one hundred tons equipped with several emission and receipt antennas. Moreover, the number of repeaters is much less restricted and can go up to several thousands for each airplane.

The air-ground/ground-air digital data transmission flow is thus increased. The increase is also due to the fact that the airplanes that transport the payloads do not go over ten kilometers which is to be compared with satellite orbits (over a hundred kilometers). The opening angle of antennas can be increased to go up to hundred and eighty degrees.

The invention enables getting network made up of constellation of passenger transport airplanes, each representing an emission and receipt module that communicates with emission and receipt earth stations.

Its implementation however requires the resolution of several new technical difficulties not specified in the current networks.

In fact, such a method is disadvantageous with regards to signal emission and receipt on the ground, considering that the flight altitude of airplanes is not fixed and that this altitude varies for a same airplane between zero kilometer (on the ground) and ten kilometers (while cruising).

To mitigate this disadvantage, one more particularly advantageous feature of the invention is that the power of signals (radiation) emitted by the payload is modulated according to the altitude of the airplane and can vary from 0% on the ground to 100% during cruising. The altitude is constantly measured on an airplane and therefore acts as data already available for implementing the method.

This modulation also helps in protecting animals and humans against the radiation received from the ground and originating from the payload on the airplanes, considering the very low flight altitude of airplanes (under ten kilometers) and considering the large emission power of payload antennas.

The invention also concerns the passenger and/or freight transport airplane that enables implementing the said method.

The airplane is remarkable in that it is equipped with at least one payload meant for the transmission and receipt of signals, and several additional antennas other than the ones required for the navigation of an airplane and implemented according to at least one of the following technologies:
antennas painted or printed on the fuselage and/or the wings of the airplane and/or fins,
“Patch” type planar antennas that cover all or part of the fuselage, and/or wings, and/or fins of the airplane.

To protect the passengers and team members from the strong radiation emitted by the payload, at least one coat of paint that absorbs the electromagnetic radiation emitted by the signals is applied to the outer surface of the airplane,

According to a particularly advantageous feature, this layer of absorbent paint is one of the first applied.

It ensures its function of protection while authorizing the use of antennas on the external layers. It protects the airplane interiors against radiation emitted from other airplanes.

According to another particularly advantageous feature of the invention that also aids in the protection, acoustic and thermal insulation materials that absorb electromagnetic radiation are applied to the internal surface of the airplane.

According to another particularly advantageous feature of the invention, the airplane's internal casing panels are made of materials that absorb electromagnetic radiation.

According to another particularly advantageous feature of the invention, the windows are made of materials that absorb electromagnetic radiation.

According to another particularly advantageous feature of the invention, the said airplane transports from two to one thousand passengers.

According to another particularly advantageous feature of the invention, the said airplane transports from fifty to one thousand passengers.

The absorption of electromagnetic radiation also prevents interference with the airplane equipment. Another particularly advantageous feature of the invention that is used in this function is that the emission frequencies of payloads transported by the airplane are different from those of navigation equipment.

According to another particularly advantageous feature of the invention where the method interconnects several airplanes, the method consists in making them communicate the signal emission and receipt earth station with the highest airplane from the multiple airplanes with which it communicates. This feature rationalizes the communication by providing the airplane that gives the widest coverage. They also participate in the protection against radiation by selecting airplanes that implement the network.

According to another particularly advantageous feature of the invention, the method is remarkable because the signal emission and receipt earth station connects only to the strongest signal.

Based on another particularly advantageous feature of the invention, the method is remarkable since when there are several strong signals, the earth station for emission and receipt of signals connects to these multiple signals, but using as means to separate from these signals:
different polarizations,
different frequencies,
azimuth targets to track the sources,

According to another particularly advantageous feature of the invention, the equipment for ground receipt consists of a dual antenna:
one upon operation and connected to the strongest signal,
one awaiting connection but continuously searching for a strong signal.

The features that enable selecting from available signals in the best conditions enable answering the technical problem related to random movement of airplanes.

According to another particularly advantageous feature of the invention, the data signals are exclusively of internet type.

According to another particularly advantageous feature of the invention, the data signals are exclusively of television type.

According to another particularly advantageous feature of the invention, the data signals include telecommunication type signals.

According to another particularly advantageous feature of the invention, the internet and/or television type data signal emission and receipt earth station is linked to one or several internet or television signal access vendors.

In fact, since the movements (trajectories) of airplanes in the sky are simply coordinated to avoid collisions, there is an issue of interference during the implementation of the method of the invention:
in partial OI total recovery on the ground of various radiations received on the ground and emitted by the payloads of various airplanes,
in interference of radiations between airplanes.
   The elements that constitute a device likely to implement the invention method are the following:
one or several internet access vendors,
one or several earth stations for the emission and receipt of signals from internet access vendor(s) with the airplanes, connected on one hand to one or several internet access vendors, and on the other hand to one or several antennas for ground-air emission and air-ground receipt of signals, for which earth bases are equipped with one or several airplanes tracking devices and for which the emission or receipt antennas may be of two groups: one group of antennas connected to the flying airplanes and another group of antennas listening and searching for new airplanes to connect,
one or several airplanes connected on one hand to one or several earth stations; on the other hand to users on the ground equipped with emission and receipt means, for which airplanes could be connected between them to extend the coverage area or cover the complete land surface,
one or several satellites (according to another feature of the invention) connected on one hand to one or several earth stations for inter-connection of internet access vendor (s) with satellite(s), on the other hand with one or several airplanes, for which airplanes are in return connected to users on the ground, equipped with means for emission and receipt.
several users on the ground equipped with means for ground-air emission of signals to airplanes and air-ground receipt of signals originating from airplanes.

According to another feature of the invention, the users on the ground can be connected to the earth stations and/or amongst them, instead of directly connecting to airplanes.

The fundamental concepts of the invention have been described above in the most simple format, other details and features shall be clearer upon reading the description that follows and upon examining the appended drawings, that give non-restrictive examples of several network embodiments obtained on the basis of the method compliant with the invention.

### BRIEF DESCRIPTION OF THE DRAWINGS

FIG. 1 shows the first embodiment according to the invention of an internet communication network;

FIG. 2 shows a second embodiment according to the invention of an internet network;

FIG. 3 shows a third embodiment according to the invention of an internet network;

FIG. 4 shows fourth embodiment according to the invention of an internet network;

FIG. 5 shows a fifth embodiment according to the invention of an internet network.

### DESCRIPTION OF PREFERRED EMBODIMENTS

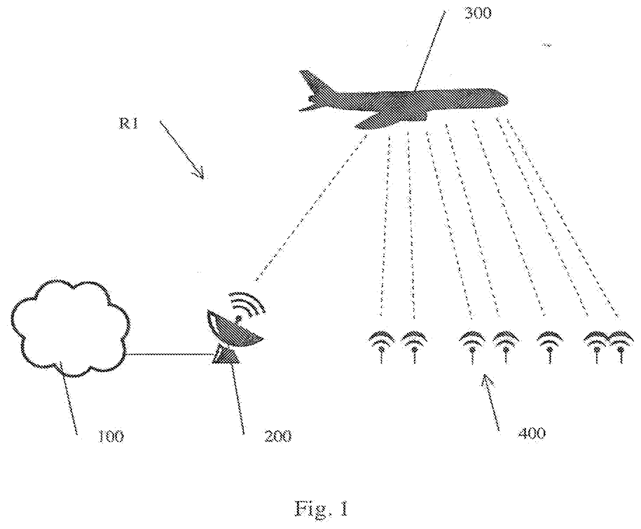

AS illustrated in the drawing in FIG. 1, the network R1 includes one or several internet access vendors 100. This or these internet access vendors are interconnected at one or several earth stations 200 of emission and receipt of internet signals.

These earth stations 200 communicate with an airplane constellation 300 (only one is illustrated) for transporting passengers, airplanes equipped for this with an internet signal emission and receipt payload. These airplanes can transport from two to over six hundred passengers.

The stations are equipped with several internet signal emission and receipt (ground-air/air-ground) antennas. They are equipped with an airplane tracking device. These multiple antennas are split into two groups:
one group of antennas connected to the airplanes in flight, and
one group of antennas listening to and searching for new airplanes to connect.

According to the invention, the emission power of stations and airplanes payload is modulated on the basis of their altitude. The said payload transported by the airplanes 300 include means for amplification and polarization of received signals.

In addition to the stations 200, users on the ground 400 equipped themselves with emission and receipt means communicate with the said airplane 300 and thus have the internet service.

As described above, the airplane 300 has all the equipment that enables protecting its passengers and equipment from radiation, with:
at least one layer of absorbent paint for electromagnetic radiation originating from received signals applied to the external surface of the airplane,
acoustic and thermal insulation materials that absorb the electromagnetic radiation applied on the internal surface of the airplane,
internal casing panels of the airplane mad of materials that absorb electromagnetic radiation.
windows made of materials that absorb electromagnetic radiation.

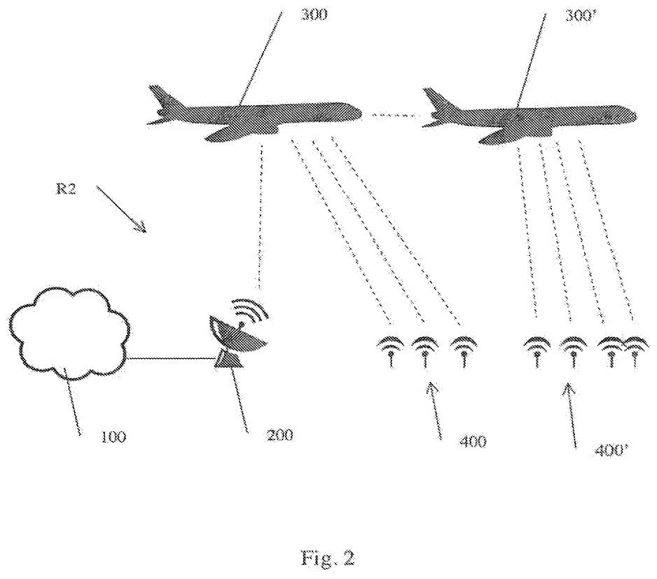

The embodiment of network R2 illustrated by the drawing in FIG. 2 shows the possibility of airplanes 300 and 300′ to connect with each other to extend the coverage area and thus cover the land surface completely.

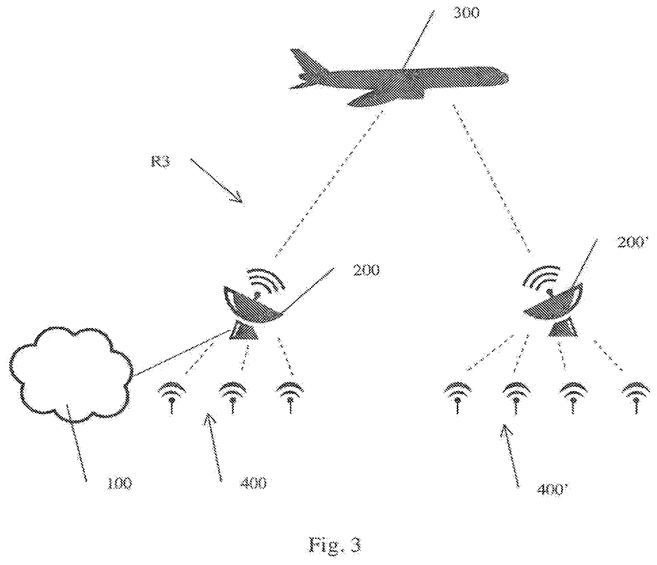

The embodiment of network R3 illustrated by the drawing in FIG. 3 shows that the users 400 and 400′ can connect beforehand to the stations 200 and 200′ that communicate with both using airplane 300 to provide internet through a vendor with access 100 available by using a single station 200.

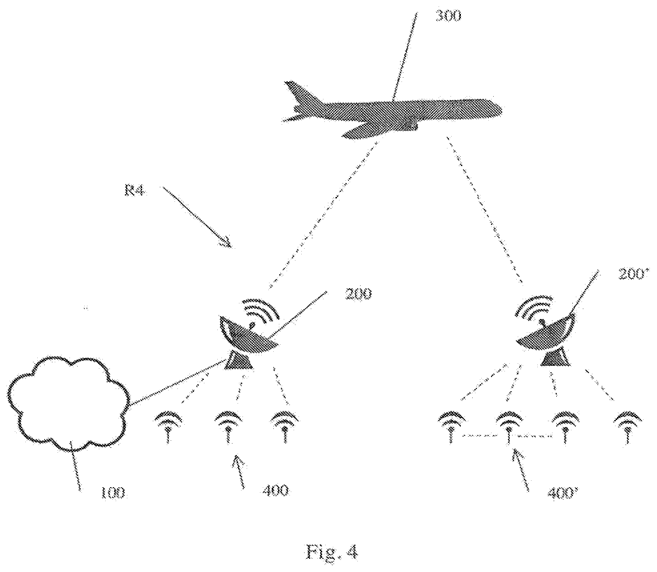

The embodiment of network R4 illustrated by the drawing in FIG. 4 shows that the users 400′ can communicate with each other before connecting to the station 200′.

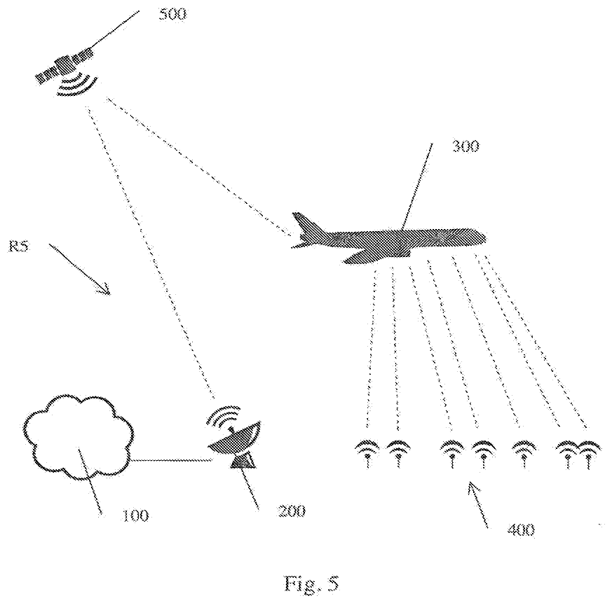

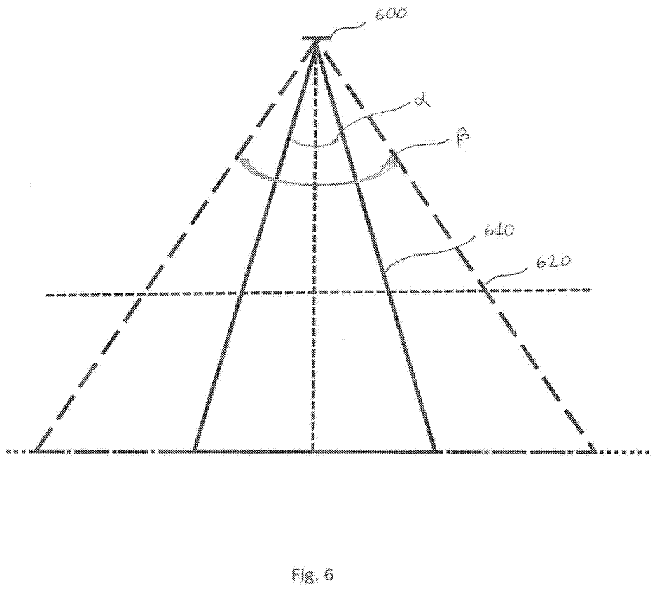

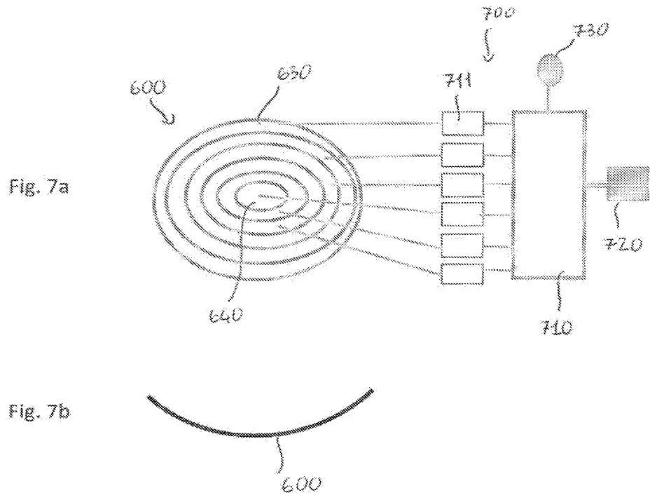

The embodiment of network R5 illustrated by the drawing in FIG. 5 integrates the presence of at least one satellite 500 connected with at least one station 200 and with at least one airplane 300; the airplanes are in return connected to users 400 on the ground.

It is understood that the method and network obtained, that have been described and shown above, were more of a revelation than a restriction. Of course, miscellaneous arrangements, modifications and improvements can be made to the example above, without having to exit from the scope of the invention.

1. Network creation method for the provision of internet and/or television type data signals across the complete land surface,
in which the surface receives
at least one earth station (200) for emission and receipt of internet and/or television type data signals,
CHARACTERIZED IN THAT it interconnects at least one airplane (300) with the earth station (200) for emission and receipt of internet and/or television type data signals on one hand and with at least one emission and receipt means for data signals of internet and/or television type that are individual or collective, fixed or borne by at least one user (400),
the said airplane transports passengers and/or freight of over five hundred kilograms,
will move to an altitude less than or equal to ten kilometers above the global land surface,
transports at least one person, and
being equipped with one or several payloads powered by the airplane's energy (300) in such a way as to use emission and receipt relays for the provision of at least one type of signal on the global land surface.

2. Method according to claim 1, CHARACTERIZED IN THAT the power of signals (radiation) emitted by the payload is modulated according to the altitude of the airplane (300) and can vary from 0% on the ground to 100% during cruising.

3. Method according to claim 1, CHARACTERIZED IN THAT the frequency of emission of payloads transported by the airplane (300) is different from that of the navigation equipment.

4. Method according to claim 1 of the type that inter-connects several airplanes, CHARACTERIZED IN THAT it involves making them communicate with an earth station (200) for emission and receipt of signals with the highest airplane (300) among the several airplanes with which they communicate,

5. Method according to claim 1, CHARACTERIZED IN THAT the earth station (200) for emission and receipt of signals are connected only to the strongest signal.

6. Method according to claim 1, CHARACTERIZED IN THAT the earth station (200) for emission and receipt of signals connects to these multiple signals, but using as means to separate from these signals:
different polarizations,
different frequencies,
azimuth targets to track the sources.

7. Method according to claim 1, CHARACTERIZED IN THAT the equipment for receipt on the ground from the earth station (200) for emission and receipt of signals, made of a dual antenna:
one upon operation and connected to the strongest signal,
one awaiting connection but continuously searching for a strong signal.

8. Method according to claim 1, CHARACTERIZED IN THAT the data signals are exclusively of internet type.

9. Method according to claim 1, CHARACTERIZED IN THAT the data signals are exclusively of television type.

10. Method according to claim 1, CHARACTERIZED IN THAT the data signals include telecommunication type signals.

11. Method according to claim 1, CHARACTERIZED IN THAT the earth station (200) for emission and receipt of internet and/or television type data signals is linked to one or several internet access (100) or television signal vendors

12. Passenger and/or freight transport airplane (300) that enables implementing the network creation method for the provision of internet and/or television type data signals across the complete land surface,
in which the surface receives
at least one earth station (200) for emission and receipt of internet and/or television type data signals,
the said method interconnects at least one airplane (300) with the earth station (200) for emission and receipt of internet and/or television type data signals on one hand and on the other hand with at least one emission and receipt means for data signals of internet and/or television type that are individual or collective, fixed or borne by at least one user (400),
the said airplane (300) transports passengers and/or freight of over five hundred kilograms,
will move to an altitude less than or equal to ten kilometers above the global land surface,
transports at least one person, and
being equipped with one or several payloads powered by the airplane's energy (300) in such a way as to use emission and receipt relays for the provision of at least one type of signal on the global land surface,
according to claim 1,
CHARACTERIZED BY THE FACT THAT it is equipped
with at least one payload meant for the transmission and receipt of signals, and
with several additional antennas other than those required for the navigation of an airplane (300) and implemented according to at least one of the following technologies:
antennas painted or printed on the fuselage and/or the wings of the airplane and/or fins,
“Patch” type planar antennas that cover all or part of the fuselage, and/or wings, and/or fins of the airplane (300).

13. Airplane according to claim 12, CHARACTERIZED BY THE FACT THAT at: least one layer of absorbent paint for electromagnetic radiation originating from signals is applied to the external surface of the airplane (300).

14. Airplane according to claim 12 or 13, CHARACTERIZED BY THE FACT THAT acoustic and thermal insulation materials that absorb electromagnetic radiation are applied to the internal surface of the airplane (300).

15. Airplane according to one of the claims from 12 to 14, CHARACTERIZED BY THE FACT THAT the airplane's internal casing panels are made of materials that absorb electromagnetic radiation.

16. Airplane according to one of the claims from 12 to 15, CHARACTERIZED BY THE FACT THAT the windows are made of materials that absorb electromagnetic radiation.

17. Airplane according to one of the claims from 12 to 16, CHARACTERIZED BY THE FACT THAT the said airplane (300) transports from two to one thousand passengers.

18. Airplane according to one of the claims from 12 to 16, CHARACTERIZED BY THE FACT THAT the said airplane (300) transports from fifty to one thousand passengers.
